(19) United States
(12) Patent Application Publication
(10) Pub. No.: US 2025/0313482 A1
(43) Pub. Date: Oct. 9, 2025

(54) LOW TEMPERATURE TRICHLOROSILANE HYDROGENATION

(71) Applicant: AGC CARBON INC., Madison, CT (US)

(72) Inventor: Sumeet Gandhi, Madison, CT (US)

(73) Assignee: AGC CARBON INC., Madison, CT (US)

(21) Appl. No.: 19/174,881

(22) Filed: Apr. 9, 2025

Related U.S. Application Data
(60) Provisional application No. 63/631,619, filed on Apr. 9, 2024.
(60) Provisional application No. 63/690,557, filed on Sep. 4, 2024.

(51) Int. Cl. C01B 33/107; B01J 21/06; B01J 23/10; B01J 23/42; B01J 23/44; B01J 23/755

(52) U.S. Cl. CPC C01B 33/1071; B01J 21/063; B01J 23/10; B01J 23/42; B01J 23/44; B01J 23/755

(57) ABSTRACT

A method for preparing trichlorosilane involves reacting silicone tetrachloride in a photo-assisted reactor, where reactant gases are fed through a gas diffusion electrode, and an electric current ionizes the reactant species in the presence of a catalyst. This process results in the formation of trichlorosilane at a temperature of less than 300° C.

### CROSS-REFERENCE TO RELATED APPLICATIONS

This application is also related to U.S. Non-Provisional patent application Ser. No. 19/174,860, Attorney Docket No. 126484-840688, filed on Apr. 9, 2025, entitled “CARBON CAPTURE USING SODIUM HYDROXIDE”; U.S. Non-Provisional Patent Application No., Attorney Docket No. 126484-840686, filed on Apr. 9, 2025, entitled “IMPROVED METAL AIR BATTERIES”, which claims the benefit of priority to U.S. provisional application No. 63/631,619, filed on Apr. 9, 2024, entitled “ELECTROSYNTHESIS OF TRICHLOROSILANE (USED INTERCHANGEABLY AS TCS OR SIHCL3) USING LOW TEMPERATURE HYDROGENATION OF SILICON TETRACHLORIDE (USED INTERCHANGEABLY AS STC OR SICL4) IN AN ELECTROLYTIC CELL REACTOR WITH CATALYST IMPREGNATED GAS DIFFUSION MEMBRANE AND WITH IR/UV LIGHT ENHANCEMENT” and U.S. provisional application No. 63/690,557, filed on Sep. 4, 2024, entitled “CARBON CAPTURE SYSTEM FOR PRODUCTION OF SODA ASH, BAKING SODA, METHANOL, & FORMALDEHYDE”. All of which are expressly incorporated by reference herein in their entireties.

### BACKGROUND

The invention described here can be used for production of various organic and inorganic chlorosilanes such as trichlorosilane, methyl chlorosilane, ethyl chlorosilane, dichlorosilane, trichlorosilane, monochlorosilane, and silane gas to name a few.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a rector in accordance with one embodiment.

FIG. 2 illustrates an example of a membrane of a reactor in accordance with one embodiment.

FIG. 3 illustrates an example of a process for making a membrane in accordance with one embodiment.

FIG. 4 illustrates an example of the components of a reactor in accordance with one embodiment.

FIG. 5 illustrates an example of components of a reactor in accordance with one embodiment.

FIG. 6 illustrates an example of a reactor in accordance with one embodiment.

FIG. 7A illustrates an example of an isometric view of the cylindrical reactor in accordance with one embodiment.

FIG. 7B illustrates an example of a side view of the cylindrical reactor in accordance with one embodiment.

FIG. 7C illustrates an example of a top view of the cylindrical reactor in accordance with one embodiment.

FIG. 7D illustrates an example of an isometric view of the cylindrical reactor in accordance with one embodiment.

FIG. 8 illustrates a routine 800 in accordance with one embodiment.

### DETAILED DESCRIPTION

In several methods for production of trichlorosilane, and more specifically to convert silicon tetrachloride (SiCl₄ or STC) to trichlorosilane (HSiCl₃ or TCS), there are significant downsides to the processes. For example, when using a direct chlorination technique, trichlorosilane is produced by treating powdered metallurgical grade silicon with blowing hydrogen chloride at 300° C. The reaction equation typically looks as follows:

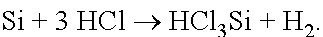

This reaction normally achieves yields of the desired product of around 80-90%. This reaction is an intermediate step in the production of solar silicon, where the trichlorosilane is distilled in a complex process and decomposed on heated hyper-pure silicon rods. This process can lead to the production of silicon, silicon tetrachloride, and hydrogen chloride, in line with the following reaction:

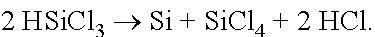

Another exemplary process is hydrochlorination, where trichlorosilane is also produced from silicon tetrachloride following the reaction mechanism:

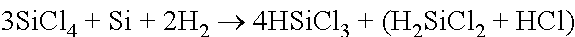

This process typically operates at a temperature of around 500° C. but achieves a yield of only about 20% due to thermodynamic limits.

Another exemplary process is the Bayer Process, where SiCl₄ is reacted with activated carbon or activated carbon-supported transition metals and barium as a promotor at around 600-900° C., which achieves a conversion rate of about 15% for SiCl₄ and HSiCl₃.

Another exemplary process is the hydrogenation of STC, where the reaction typically follows the following reaction equation:

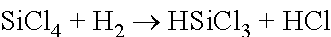

This reaction typically takes place at temperatures greater than 1000° C. and only achieves a conversion rate of about 20% to SiCl₄ while consuming ˜1.3 kWh/kg.

Another exemplary process is the reduction with hydride. This reaction involves the reduction of silicon tetrachloride using hydride sources, e.g., lithium aluminum hydride (LiAlH₄) or diisobutylaluminum hydride (DIBAL-H), at low temperatures. The reaction can be represented as:

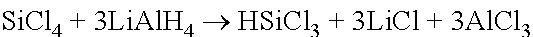

Another exemplary process is silane reduction. In this reaction, silicon tetrachloride can be converted to trichlorosilane through the reduction of silane gas (SiH₄) with hydrogen chloride (HCl) in the presence of a catalyst. This reaction is carried out at high temperatures and results in the formation of trichlorosilane.

Another exemplary process is the direct chlorination of silane. In this reaction, trichlorosilane can be obtained by the direct chlorination of silane gas (SiH₄) using chlorine gas (Cl₂) in the presence of a catalyst. This method involves the reaction:

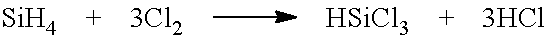

Another exemplary process is plasma-assisted conversion. In this reaction, silicon tetrachloride can be converted to trichlorosilane using plasma-enhanced chemical vapor deposition (PECVD) techniques. In this method, a plasma is used to break down the Si—Cl bonds in SiCl₄, leading to the formation of trichlorosilane.

Currently, a process to convert SiCl₄ into HSiCl₃ in high yields while being economically feasible is still needed. It would be significantly advantageous to achieve selective monohydrogenation of SiCl₄ that results in HSiCl₃. However, reduction of SiCl₄ with common reducing agents, e.g., LiH, typically results in the perhydrogenated SiH₄ quantitatively lacking in any selectivity towards HSiCl₃. A process of manufacturing HSiCl₃ where silicon is reacted with gaseous HCl in a direct process in a fluidized bed reactor at 300-450° C. in large scale is governed by the following reaction:

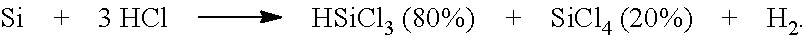

Using this method results in a large amount of SiCl₄ formed according to:

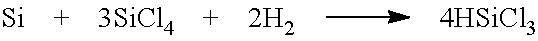

However, the reaction requires excessive heat, e.g., a temperature of about 500° C. and only yields about 20% of the desired product.

When a direct synthesis of HSiCl₃ is used, the HiSiCl₃ is contaminated with impurities such as chlorides of boron, phosphorous, and arsenic, along with traces of hydrocarbons. Performing the HSiCl₃ deposition to give silicon and HCl provides a conversion of only one-third of silicon to polysilicon, whereas one-third is converted to SiCl₄, and one-third is unconverted, leaving the reactor exhaust gas that includes the remaining HCl. The HSiCl₃ formation is also dependent on silicon quality. Higher-quality technical grade silicon requires higher temperatures for the reaction, but it also produces more SiCl₄. Lower quality grades of silicon, including pure and highly pure silicon, produce lesser amounts of SiCl₄, but increase the overall costs. At higher temperatures, H₂SiCl₂ forms from the disproportionation of HSiCl₃, which results in SiCl₄. Thus, silicon impurities catalyze SiCl₄ formation.

The technical processes to produce semiconductor silicon are based on CVD (chemical vapor deposition) of chlorosilanes or silanes. The process based on chlorosilanes has the shortcoming of only about 25% of the chlorosilane used is converted into the final silicon product, but about 75% is converted into the by-product silicon tetrachloride (SiCl₄). As 75% of the worldwide hyper pure silicon production is based on the Siemens Process using HSiCl₃ as starting material, it is the major factor for economics to profitably dispose of SiCl₄, which is currently converted to fumed silica (SiO₂) as a common disposal process. Fumed silica forms from the SiCl₄ using a hydrolysis reaction at high temperatures, which reduces the economic benefit of the process. Until now, intensive efforts to convert SiCl₄ into HSiCl₃ were concentrated on the development of processes of homogenous gas-phase hydrogenation at 1200° C. and of hydrogenation in the presence of metallurgical silicon at 600° C. Much work was investigated in the hydrodehalogenation of chlorosilanes in the presence of metal silicides, but reaction temperatures for HSiCl₃ recovery were high (˜600° C.) and yields were low (conversion rates SiCl₄/HSiCl₃ 4-7 mol %). The technically preferred reaction is:

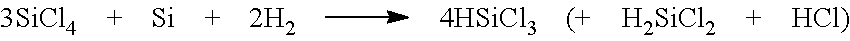

This reaction is performed at 500° C. with a thermodynamically limited yield of 20%. In the Bayer Process, SiCl₄ is reacted with activated carbon or activated carbon-supported transition metals while using barium as a promoter at temperatures between 600° C. and 900° C. This results in a SiCl₄/HSiCl₃ conversion rate of about 15% for the following reaction:

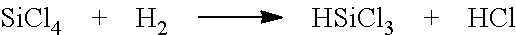

The temperatures for this reaction typically exceed 1000° C. to complete the reaction. Further, the conversion rate is only about 20% while the energy consumption is ˜1.3 kWh/kg SiCl₄.

Accordingly, there has been a strong demand for an economically viable process for selectively preparing trichlorosilane in high yields from easily available starting materials, which process is energy efficient, proceeds at low temperatures, and which allows a simple separation of the trichlorosilane from by-product.

The present disclosure allows for the production of low-temperature silicon tetrachloride hydrogenation to make trichlorosilane. The innovative reactor design uses an electrolytic cell-style reactor consisting of an anode filled with STC and hydrogen on the cathode side; a gas diffusion membrane with a catalyst consisting of nickel, palladium, platinum, iridium oxide, or ruthenium oxide coating. The gas diffusion electrode can be lined with, for example, PTFE, a block copolymer, polysulfone, polyamide, polycarbonate, or any suitable semipermeable membrane, as long as it has the appropriate porosity and reactivity. The membrane can have a catalyst embedded to increase the efficiency of the hydrogenation reaction. The top cover of the anode has UV light to minimize the energy consumption of STC hydrogenation. The electrolytic cell is made of multiple cells with the use of bipolar plates in between, through which hydrogen is fed to two anodes. The operating temperature of the reactor is from 60° C. to 200° C. The operating pressure of hydrogen ranges from atmospheric to 5 bar_{g}. The reactor design uses gas-tight seals with a PTFE gasket slot on the bipolar plates. Both anode and cathodes have inlet and outlet ports for the STC and the hydrogen feed. Notably, this same method can be extended for the production of other chlorosilanes, including methyl chlorosilane and ethyl chlorosilane.

The present disclosure provides a new design that includes an electrosynthesis reactor consisting of an anode, a cathode, a gas diffusion electrode with catalysts, a hydrophobic PTFE membrane, multiple bipolar plates, a UV/IR lights, inlet ports for reactants such as STC and H₂, and outlet ports for key product such as TCS.

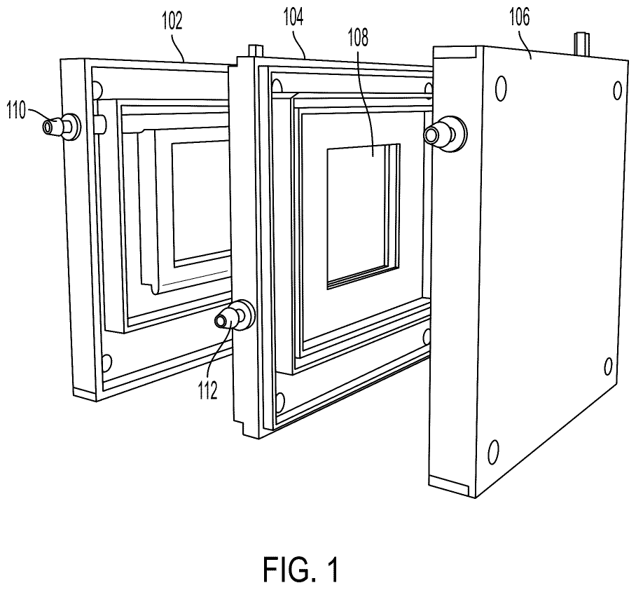

FIG. 1 illustrates an exemplary design of a reactor 100 that is consistent with the present disclosure. FIG. 1 is provided as an example to aid in describing the present technology. Although a particular arrangement of components is depicted in FIG. 1, the arrangement of such components should not be considered limiting of the present technology unless otherwise specified in the appended claims.

In one example, and as shown in FIG. 1, the reactor 100 includes a single cell design for an electrolytic reactor. In further examples, multiple cells can be used together to form a multi-cell design of the reactor 100, as will be discussed in detail below. Each cell includes an endplate 102 and an endplate 106 that are anodes in the electrolytic cell of reactor 100. Endplate 102 and endplate 106 represent the opposing ends of the reactor 100, with the reaction chamber 104 between the two endplates 102 and 106. Furthermore, the endplates 102 and 106 can be the anodes for the electrolytic reaction in reactor 100. Alternatively, the multi-cell design for reactor 100 can include bipolar plates (not shown) to connect multiple cells together. The endplates 102 and 106 can include hydrophobic microporous channels to assist the hydrogenation reaction and distribute the reactants to the catalytic sites in the hydrophilic layer. The surfaces of the anode, e.g., endplates 102 and 106, and the cathode, include a uniform adhesion of a current collector and electrode material for even distribution of potential over the surface of each electrode. In one example, each of the electrodes is electroplated with copper or nickel for use as the current collector. The endplates 102 and 106 can also include a port for adding hydrogen gas to the multi-cell reactor 400. Further, the endplates 102 and 106 anode layers in the reactor 100 can include a hydrogen port 110 hydrogen feed in a port in the endplates 102 and/or 106. Endplates 102 and 106 can also be used by the reactor 100 as compression plates to apply force to seal the reactor against leaks.

The electrodes for the electrolytic reactors, e.g., reactor 100 and multi-cell reactor 400, single cell reactor 500, single cell reactor 600, or cylindrical cell reactor 700, can be chosen based on the activation overpotential for the evolution of hydrogen, oxygen. For example, Table I, below, provides potential electrode materials for use in the electrolytic reactors, based on a temperature of 25° C.

TABLE I

| Electrode Material | Hydrogen | Oxygen | Chlorine |
|---|---|---|---|
| Silver | −0.59 V | +0.61 V | |
| Aluminum | −0.58 V | | |
| Gold | −0.12 V | +0.96 V | |
| Beryllium | −0.63 V | | |
| Bismuth | −0.33 V | | |
| Cadmium | −0.99 V | +0.80 V | |
| Cobalt | −0.35 V | +0.39 V | |
| Copper | −0.50 V | +0.58 V | |
| Iron | −0.40 V | +0.41 V | |
| Gallium | −0.63 V | | |
| Mercury | −1.04 V | | |
| Indium | −0.80 V | | |
| Molybdenum | −0.24 V | | |
| Niobium | −0.65 V | | |
| Nickel | −0.32 V | +0.61 V | |
| Lead | −0.88 V | +0.80 V | |
| Palladium | −0.09 V | +0.89 V | |
| Platinum | −0.09 V | +1.11 V | +0.10 V |
| Platinum (Platinized) | −0.01 V | +0.46 V | +0.08 V |
| Stainless Steel | −0.42 V | +0.28 V | |
| Graphite | −0.47 V | +0.50 V | +0.12 V |

In a further aspect of an exemplary embodiment of reactor 100, the endplates 102 and 106 can include hydrophilic microporous channels. The hydrophilic microporous channels are made up of catalyst particles, making the hydrogenation reaction more efficient. Exemplary catalysts for use in reactor 100 include nickel, palladium, platinum, iridium oxide, or ruthenium oxide, each of which assists the reaction to TCS. The presence of a hydrogen electrocatalyst lowers the activation overpotential required to effectively hydrogenate tetrachlorosilane (SiCl₄ or STC) and speeds up the bond activation and cleavage to effectively initiate the hydrogenation process. The practical electrolytic cell potential for hydrogenation of silicon tetrachloride is expected to be greater than the theoretical one known as overpotential due to internal loss of cell activation, ohmic, and concentration losses. Practically, the electrochemical reaction kinetics of silicon tetrachloride hydrogenation using hydrogen at the cathode is lethargic without the presence of a catalyst.

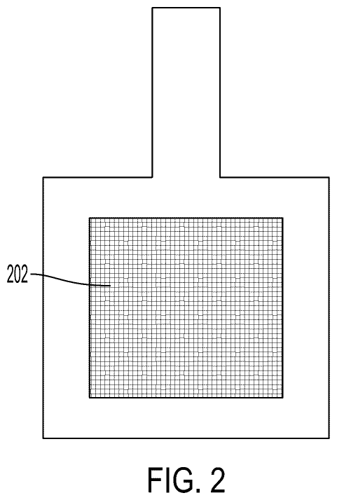

In a further aspect of an exemplary embodiment of reactor 100, the reactor 100 can include the reaction chamber 104 between, for example, the endplates 102 and 106. The reaction chamber 104 can include a gas diffusion membrane 202 that is impregnated with a catalyst. The reaction chamber 104 includes a membrane mount 108, where the gas diffusion membrane 202 of FIG. 2 (not shown) can be included in the reactor 100. The gas diffusion membrane 202 can be used to facilitate the hydrogenation reaction in reactor 100. The gas diffusion membrane 202 can have a thickness of around 500 microns or less, more preferably around 350 microns or less, and most preferably between 100 and 200 microns. In a further aspect of an exemplary embodiment, the activity of hydrogen electro-catalysts at the hydrogen electrode can be influenced by the gas diffusion membrane 202 made up of carbonaceous substances and a wet-proofing binder including polytetrafluoroethylene to adjust to a membrane porosity between 15% and 50%, and most preferably between 40% to 50%. Furthermore, the area of the gas diffusion membrane 202 is selected to adjust the production rate of the key products, such as trichlorosilane.

In a further aspect of an exemplary embodiment where STC hydrogenation takes place in reactor 100, the current density on the gas diffusion membrane 202 can be is between 5 to 600 mA/cm², or more preferably in the range of 5 to 400 mA/cm², and most preferably is less than 400 mA/cm² so as to minimize overpotential while managing the rate of reaction.

The reaction chamber 104 can also include a UV light source and/or an IR light source. The UV light source is preferably in the range of 10 nm to 400 nm, more preferably 40 nm to 400 nm, and most preferably 200 nm to 320 nm. The IR light is preferably in the range of 1.4 μm to 15 μm, more preferably 8 μm to 15 μm, and most preferably 12.5 μm. Furthermore, the multi-cell reactor 400 can conduct the reaction without the use of UV or IR light. The UV light source and/or IR light source can be placed at the top of reaction chamber 104 to conserve energy usage during hydrogenation. It is also possible to include the UV and/or IR light in the endplates 102 and 106, such that the light is transferable to the reaction chamber.

Two absorption bands were identified for the hydrogenation of STC-one under UV light for hydrogen and chlorine reactions and the other for STC absorption. Wavelengths to consider when choosing the output of the light source include Methane (CH₄) has absorption bands in the infrared region around 2917 cm⁻¹ (asymmetric stretching) and 2963 cm⁻¹ (symmetric stretching) due to C—H stretching vibrations. Chlorine gas (Cl₂) has absorption bands in the infrared region around 546 cm⁻¹ (bending vibration) and 781 cm⁻¹ (stretching vibration) due to the Cl—Cl bond vibrations.

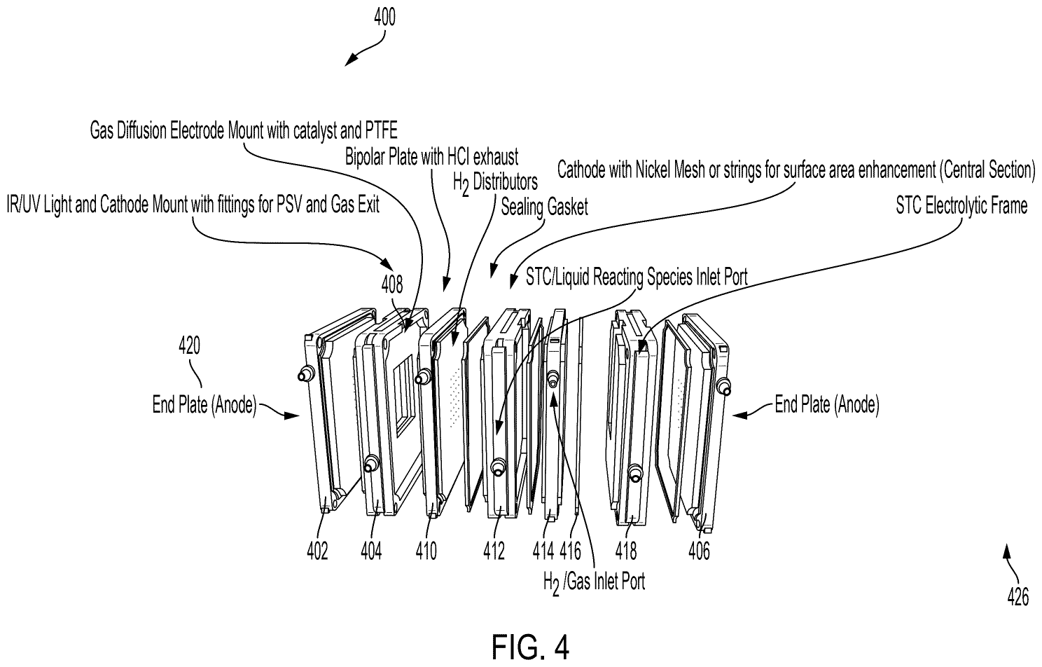

UV light can be provided in the range of 190 to 200 nm, on the top cover adjacent to the anode, e.g., 102 and 106, of FIG. 1, and/or bipolar plate 410 and bipolar plate 426 of FIG. 4, for reduced energy consumption during STC hydrogenation. The estimated power consumption per UV light is between 50 to 95 W.

In the dissociation of STC into TCS using photochemical methods, several operating parameters can influence the reaction, including:
Wavelength of Light: Selection of an appropriate wavelength of light that can efficiently break the Si—Cl bonds in STC.
Intensity of Light: The intensity of light affects the rate of dissociation. Higher intensity light can lead to faster dissociation.
Temperature: Controlling the temperature can optimize the reaction rate. Higher temperatures can enhance the dissociation process. The temperature range for the current disclosure can be from 60° C. to 200° C. STC can thus be in the liquid phase or in gas phase as STC has covalent bonds and not ionic bonds.
Pressure: Adjusting the pressure can also influence the reaction rate and yield. The pressure can be adjusted in any of the reactors 100, 400, 500, 600, or 700, including using the hydrogen to maintain a pressure between atmospheric and 10 bar_{g}. Another aspect of an exemplary embodiment of reactor 100 is that when UV and/or IR light exposure are utilized with the reactor 100, the pressure can be less than 10 bar_{g}, more preferably less than 5 bar_{g}, and most preferably at atmospheric pressure.
Catalyst loading rate: Catalysts can enhance the efficiency of the dissociation process, allowing for lower energy requirements or faster reaction rates. The porous membrane 200 may have 0.5% to 20% catalyst for hydrogenation process.
Duration of IR/UV Exposure: The STC retention time in the reactor and its exposure to IR/UV light can affect the extent of dissociation of STC into TCS, DCS, or MCS.
Diffusion of Hydrogen in STC: H₂ diffusion in STC is considered low and STC may be required to be fed in the vapor phase. However, the porous membrane 200 described herein below in FIG. 2 is expected to have sufficiently high porosity to have a reaction rate limiting mechanism instead of diffusion rate limiting mechanism.
Ionic conductivity of STC: Since STC forms covalent bonds, STC does not have ionic conductivity. However, chlorine and hydrogen react vigorously under UV light, and this may be enough to initiate the hydrogenation reaction.
Porosity of the membrane: Expected porosity of porous membrane 200 of FIG. 2, is between 20% and 50%
Current Density: The estimated current density for the electrolytic cell-style reactors described in the present disclosure is between 100 to 200 mA/cm².
H₂:Ar Ratio: Ratio of H₂ to Ar in the feed gas can be used to control byproduct formation such as DCS and MCS
Membrane Thickness: The porous membrane 200 can have a thickness of between 200 to 350 microns
Membrane Area: the porous membrane 200 can have a similar area as related to the production through electrolysis

Each of these parameters can be optimized to achieve the efficient dissociation of STC into TCS.

FIG. 2 illustrates an exemplary design of a gas diffusion membrane 202 that is consistent with the present disclosure. The gas diffusion membrane 202 is provided as an example to aid in describing the present technology. Although a particular arrangement of components is depicted in FIG. 2, the arrangement of such components should not be considered limiting of the present technology unless otherwise specified in the appended claims.

The gas diffusion membrane 202 can be utilized within membrane mount 108 of reaction chamber 104 of FIG. 1. In one example of the gas diffusion membrane 202 of FIG. 2 is a porous membrane with greater than 20% porosity, more preferably greater than 25% porosity, and most preferably greater than 50% porosity. In one exemplary embodiment, the membrane 202 can have an area of 25 cm² and create 200-300 milliamps per cm². The membrane can be less than 400 microns thick, more preferably less than 200 microns thick. Further, if the membrane is created out of PTFE or ePTFE, then the membrane can be as thin as 10 microns and provide a semi-permeable membrane. In a further example consistent with this disclosure, PTFE can be sprayed onto the membrane 202 to allow for changing thicknesses. Another example consistent with the current disclosure is to create the semipermeable membrane 202 out of a binding agent, e.g., PVDF. To increase the surface area of membrane 202, fine conductive particles can be embedded into membrane 202, which will increase the surface area of membrane 202

One method for improving the porosity of gas diffusion membrane 202 is to utilize 3-D printing technology. 3-D printing the gas diffusion membrane 202 improves the mechanical strength of the membrane, which allows for the lifespan of the membrane to increase. The gas diffusion membrane 202 also has improved hydrogen flux due to the increased porosity, which improves the efficiency of the hydrogenation reaction. 3-D printing the membrane also increases the ease of changing the membrane for different applications. For example, different catalysts can be used for different conditions. It also allows the membrane 202 of FIG. 2 to be coated with a catalyst, carbon, and/or PTFE or ePTFE. Alternatively, the membrane can be constructed out of Faraday's fabric coated with a catalyst and PTFE, a non-woven fabric, or a similar porous membrane that offers a high surface area for the ionization of oxygen and hydrogen ions. An additional bonding layer of PTFE with the membrane is performed either through heat press or through roll-to-roll process, this can also be used with the PTFE and fine particles embodiment to create a tightly bound proper membrane. Furthermore, an additional activated carbon, graphite, or conductive powdered layer may be embedded onto the membrane to increase the surface area either through a powder coating process or through spray coating the membrane.

In a further aspect of the disclosure, the gas diffusion membrane 202 can have the catalyst loaded onto the membrane to form a three-phase boundary between the reactants on the anode and the cathode. However, it should be noted that the catalyst may also be added to the liquid reactant(s) or liquid-gas reactants and fed into the reactor 100 of FIG. 1, for example.

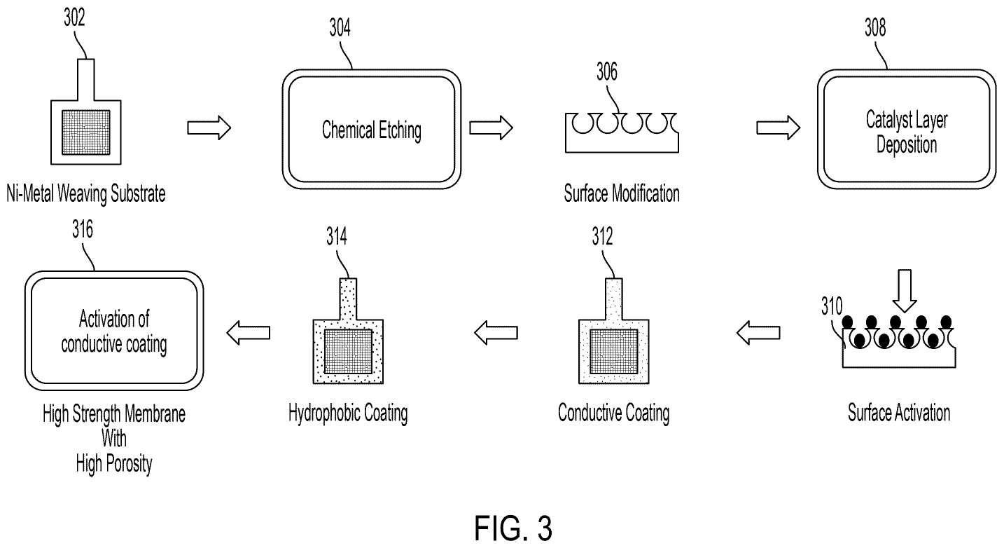

One exemplary process for creating the porous membrane 200 for use in reactor 100 is provided in FIG. 3.

FIG. 3 illustrates an exemplary design process 300 of a porous membrane 200 that is consistent with the present disclosure. FIG. 3 is provided as an example to aid in describing the present technology. Although a particular arrangement of components is depicted in FIG. 3, the arrangement of such components should not be considered limiting of the present technology unless otherwise specified in the appended claims.

Initially, at one exemplary step of design process 300, step 302 includes the substrate of the gas diffusion membrane 202 of FIG. 2 being a nickel metal substrate that needs to be prepared for the hydrogenation reaction. The nickel metal substrate can be created via 3-D printing or weaving metal strands together. Some exemplary methods of 3-D printing include metal powder bed fusion, which can include laser melting technology and/or laser sintering. Both of which utilize the underlying metal or alloy, e.g., nickel or nickel alloy, as the basis for building a porous membrane out of the chosen metal.

At a further exemplary step of design process 300, step 304, the nickel metal substrate is chemically etched to prepare the nickel metal substrate for further modification. For example, chemical etching can help improve the porosity of the membrane or the pore sizes used in the membrane. This step can also be used to remove any additional preparatory materials used to make the nickel metal substrate. At exemplary step 306, the surface of the nickel metal substrate can be modified using surface modification procedures. This surface modification can include cleaning the surface of any remaining contaminants and can roughen the surface to make the catalyst deposition more robust.

At exemplary step 308, the catalyst can be embedded into the gas diffusion membrane 202 via a deposition process. If the gas diffusion membrane 202 used for the hydrogenation reaction is going to include one of the chosen catalysts, e.g., nickel, palladium, platinum, iridium oxide, or ruthenium oxide. After the layer of the catalyst is formed, in step 310 the catalyst is activated. This can take place via calcination, reduction, or electrochemical activation. After the catalyst is activated, in exemplary step 312, a conducive coating is added to the gas diffusion membrane 202. Next, in exemplary step 314, a hydrophobic coating is added. For example, a PTFE can be added to the membrane. Finally, at exemplary step 316, the conductive coating from step 312 can be activated by electrochemical activation, chemical treatment, or thermal treatment.

FIG. 4 illustrates an exemplary design of a multi-cell reactor 400 that is consistent with the present disclosure. FIG. 4 is provided as an example to aid in describing the present technology. Although a particular arrangement of components is depicted in FIG. 4, the arrangement of such components should not be considered limiting of the present technology unless otherwise specified in the appended claims.

In one example, and as shown in FIG. 4, the multi-cell reactor 400 includes a multi-cell design, based on the single cell design of FIG. 1. If multiple cells are used, the cells are separated by a bipolar plate 406. Each cell includes an endplate 402 and an endplate 406 that act as anodes in the electrolytic cell of multi-cell reactor 400 and are on opposing ends of the multi-cell reactor 400. The multi-cell reactor 400 includes bipolar plate 410 between reaction chamber 404 and reaction chamber 412 and bipolar plate 414 between reaction chamber 412 and reaction chamber 418. The bipolar plates 410 and 414 can include gas-tight seals, and the seal can be implemented via a polytetrafluoroethylene (PTFE) gasket, e.g., sealing gasket 416. Endplates 402 and 406, along with bipolar plates 410 and 414, can include hydrophobic microporous channels to assist the hydrogenation reaction and distribute the reactants to the catalytic sites in the hydrophilic layer. The surfaces of the anode, e.g., endplates 402 and 406, and the bipolar plates 410 and 414, can include a uniform adhesion of a current collector and electrode material for even distribution of potential over the surface of each electrode. In one example, each of the electrodes is electroplated with copper or nickel for use as the current collector. The endplates 402 and 406 as well as the bipolar plates 410 and 414, can also include a port for adding hydrogen gas to the multi-cell reactor 400. The endplates 402 and 406 can also include exhaust ports for hydrochloric acid (HCl), a product of the reaction. Endplates 402 and 406 can also be used by the multi-cell reactor 400 as compression plates to apply enough force to seal the reactor against leaks.

In a further exemplary aspect of multi-cell reactor 400, both the endplates 402 and 406, and the bipolar plates 410 and 414 can include hydrophilic microporous channels. The hydrophilic microporous channels are made up of catalyst particles, making the reaction more efficient. Exemplary catalysts for use in multi-cell reactor 400 include nickel, palladium, platinum, iridium oxide, or ruthenium oxide, each of which assists the reaction to TCS. The presence of a hydrogen electrocatalyst lowers the activation overpotential required to effectively hydrogenate tetrachlorosilane (SiCl₄ or STC) and speeds up the bond activation and cleavage to effectively initiate the hydrogenation process. The practical electrolytic cell potential for hydrogenation of silicon tetrachloride is expected to be greater than the theoretical one known as overpotential due to internal loss of cell activation, ohmic, and concentration losses. Practically, the electrochemical reaction kinetics of silicon tetrachloride hydrogenation using hydrogen at the cathode is lethargic without the presence of a catalyst.

In a further aspect of an exemplary embodiment of multi-cell reactor 400, the multi-cell reactor 400 can include a sealing gasket 416, between, for example, the bipolar plate 414 and reaction chamber 418. Further, the reaction chambers 404, 412, and 418 have membrane mounts, e.g., membrane mount 408, that can include a gas diffusion membrane 202 of FIG. 2 that is impregnated with a catalyst. The gas diffusion membrane 202 can have a thickness of around 500 microns or less, more preferably around 350 microns or less, and most preferably between 100 and 200 microns. In a further aspect of an exemplary embodiment, the activity of hydrogen electro-catalysts at the hydrogen electrode can be influenced by the gas diffusion membrane 202 made up of carbonaceous substances and a wet-proofing binder including polytetrafluoroethylene to adjust to a membrane porosity between 15% and 50%, and most preferably between 40% to 50%. Furthermore, the gas diffusion membrane 202 area is selected to adjust the production rate of the key products, such as trichlorosilane.

The reaction chambers 404, 412, and 418 can also include a UV light source and/or an IR light source. The UV light source is preferably in the range of 10 nm to 400 nm, more preferably 400 nm to 400 nm, and most preferably 420 nm to 200 nm. The IR light is preferably in the range of 1.4 μm to 15 μm, more preferably 8 μm to 15 μm, and most preferably 12.5 μm. Furthermore, the multi-cell reactor 400 can conduct the reaction without the use of UV or IR light. Wavelengths to consider when choosing the output of the light source include Methane (CH₄) has absorption bands in the infrared region around 2917 cm⁻¹ (asymmetric stretching) and 2963 cm⁻¹ (symmetric stretching) due to C—H stretching vibrations. Chlorine gas (Cl₂) has absorption bands in the infrared region around 546 cm⁻¹ (bending vibration) and 781 cm⁻¹ (stretching vibration) due to the Cl—Cl bond vibrations.

Another aspect of an exemplary embodiment of multi-cell reactor 400, is that when UV and/or IR light exposure are utilized with the multi-cell reactor 400, the pressure can be less than 10 bar_{g}, more preferably less than 5 bar_{g}, and most preferably at atmospheric pressure.

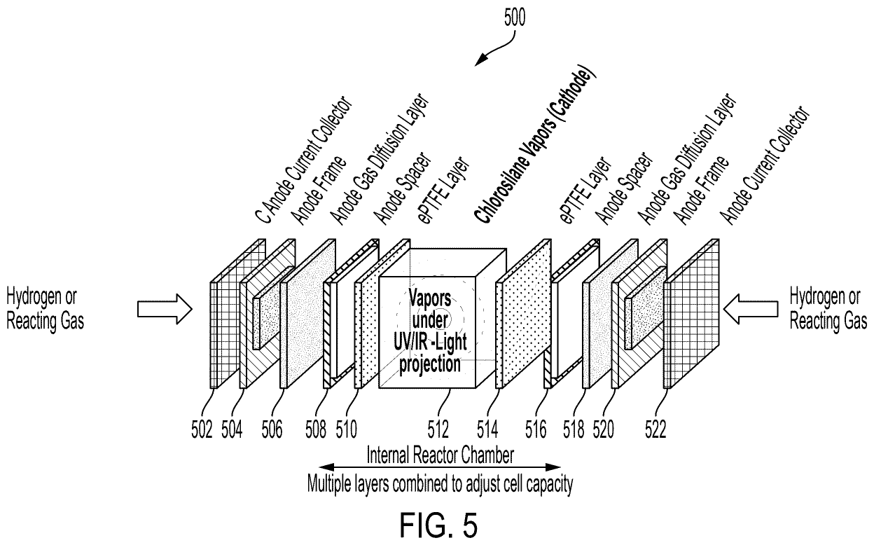

FIG. 5 illustrates an additional exemplary design of a single-cell reactor 500 that is consistent with the present disclosure. FIG. 5 is provided as an example to aid in describing the present technology. Although a particular arrangement of components is depicted in FIG. 5, the arrangement of such components should not be considered limiting of the present technology unless otherwise specified in the appended claims.

In one example, hydrogen or a reacting gas enter the single cell reactor 500 through the anode current collector 502 and/or anode current collector 522 of FIG. 5. The single cell reactor 500 then has two anode frames 504 and 520 that each include an anode for the single cell reactor 500 and interact with anode current collectors 502 and 522, respectively. The anode current collectors 502 and 522 and anode frames 504 and 520 are layers that can be present in the endplates 102 and 106 of FIG. 1. The single cell reactor 500 of FIG. 5 can then have anode gas diffusion layers 506 and 518. The anode gas diffusion layers 506 and 518 include the gas diffusion membrane 202 described in FIG. 1 and FIG. 2. The anode gas diffusion layers 506 and 518 can be within the internal reactor chamber 512 of the single cell reactor 500, thereby both controlling the flow of gasses within the internal reactor chamber 512 as well as catalyzing the hydrogenation reaction to form trichlorosilane. Single cell reactor 500 can also include PTFE layers 510 and 514 between the anode spacer 508 and the internal reactor chamber 512 and between anode spacer 516 and internal reactor chamber 512. The PTFE layers 510 and 514 can be either conventional PTFE or elongated PTFE to take advantage of a more flexible structure. The single cell reactor 500 also includes the internal reactor chamber 512, which is subject to UV/IR light projection and utilizes the chlorosilane as a cathode layer. While this has been referred to as a single cell reactor, as discussed above with respect to FIG. 4, single cell reactors can be combined into multicell reactors by adding bipolar pates, e.g., bipolar plates 410 and 414 of FIG. 4, to combine multiple single cell reactors, e.g., single cell reactor 500.

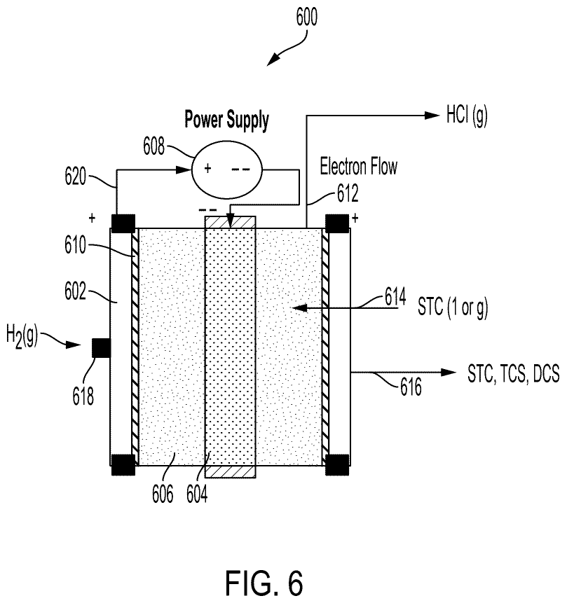

FIG. 6 illustrates an additional exemplary design of a single cell reactor 600 that is consistent with the present disclosure. FIG. 6 is provided as an example to aid in describing the present technology. Although a particular arrangement of components is depicted in FIG. 6, the arrangement of such components should not be considered limiting of the present technology unless otherwise specified in the appended claims. The components, e.g., the electrodes are in fluid communication with the electrolyte.

FIG. 6 is an exemplary embodiment of a cylindrical reactor that is consistent with the aspects of the present disclosure. Specifically, single cell reactor 600 hydrogenates STC to form TCS and HCl. For example, single cell reactor 600 includes a vessel with a cathode 602 and anode 604. The single cell reactor 600 can include a membrane 610 that can be a gas diffusion membrane with an embedded catalyst consisting of nickel, palladium, platinum, iridium oxide, or ruthenium oxide. The reactants are placed with the electrolyte in reaction chamber 606 via STC inlet 614 and hydrogen inlet 618, and the reactants, e.g., STC and hydrogen, absorb onto the catalyst and disassociate into TCS, using photo-chemical methods. For example, the single cell reactor 600 can include UV and/or IR light to facilitate further the hydrogenation reaction of STC to form TCS. Charge can flow from the cathode 602 to the anode 604 through circuit 620 to the power supply 608. The byproduct of HCl can be removed via HCl port 612. The STC inlet 614 is used to add STC to the reaction chamber 606 of single cell reactor 600 of FIG. 6. The products of the reactions, e.g., TCS, can be removed via TCS outlet 616.

FIG. 6, represents the half reactions between STC on the anode and hydrogen on the cathode. The open circuit voltage of an electrolytic cell depends on the standard electrode potentials of the half-reactions occurring at the anode and cathode.

The cathode (reduction) can be represented as follows:

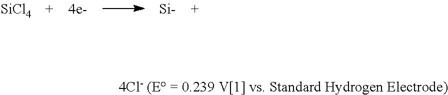

$$Eo = \frac{{Δ}_{f} {H}^{o}}{zF} = \frac{285 , 840 \frac{J}{mol}}{2 * 96 , 485 \frac{C}{mol}} = 1.481 \frac{Volts}{cell}$$

The TCS dissociation can be represented as follows:

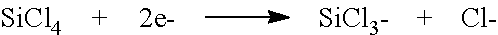

E=E₀−(0.0592×1)log({ratio of TCS/STC}); TCS yield is expected to be 12.2%=0.7−0.06V
Δ_{f}Gₒ(SiCl₄, g)=−622.72 KJ/mol; Δ_{f}Gₒ(SiCl₄, 1)=619.90144 KJ/mol, and Δ_{f}Gₒ(TCS, 1)=−482.58256 kJ/mol the cathode.

The cathodic current observed at potentials from 0.70 to 0.20 V corresponds to the reduction reactions involving STC. Thus, the cathodic current found at more positive potentials than 0.239 V may be attributed to the formation of partially reduced silicon chloride complexes, SiₘClₙ [n/m<4]

The anode (oxidation) can be represented as follows:

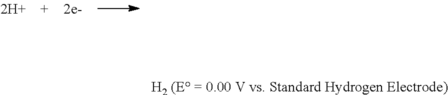

The open circuit voltage (E_{cell}) of the cell is obtained by subtracting the standard reduction potential of the anode from the standard reduction potential of:

$${E}_{cell} = {E}_{cathode}^{o} - {E}_{anode}^{o}$$

$${E}_{cell} = - 0.2 V - 0. V$$

$${E}_{cell} = - 0 \text{.20} V$$

Therefore, the open circuit voltage of the electrolytic cell with silicon tetrachloride on the anode and hydrogen on the cathode would be −0.20 volts.

### REACTION KINETICS (BUTLER-VOLMER EQUATION)

The Butler-Volmer equation is:

$$j = {j}_{0} \cdot \{ exp [ \frac{{α}_{a} zF}{R T} ( E - {E}_{eq} ) ] - exp [ - \frac{{α}_{c} zF}{R T} ( E - {E}_{eq} ) ] \}$$

or in a more compact form:

$$j = {j}_{0} \cdot \{ exp [ \frac{{α}_{a} zF η}{R T} ] - exp [ - \frac{{α}_{c} zF η}{R T} ] \}$$

where:
j: electrode current density, A/m² (defined as j=I/S)
j₀: exchange current density, A/m²
E: electrode potential, V (˜0.7 V)
E_{eq}: equilibrium potential, V (˜0.2 V)
T: absolute temperature, K
Z: number of electrons involved in the electrode reaction (2)
F: Faraday constant
R: universal gas constant
αc: cathodic charge transfer coefficient, dimensionless. (0.6)
αa: anodic charge transfer coefficient, dimensionless (0.4)
activation overpotential (defined as η=E−E_{eq}).

Where, exchange current density, J₀ is

$${j}_{0} = {Fk}_{0} ( {C}_{oxy}^{1 - β} {C}_{red}^{β} )$$

C_{oxy}: the concentration of the oxidized species (assuming H₂ at 10 to 20%)
C_{red}: the concentration of the reduced species (assuming STC at 80 to 90%)
β: a symmetry factor (0.5).
F: Faraday constant=96485 coulombs per mole
Ko: reaction rate constant=2×10⁻³ per see at 1050° C.; and 9.3×10⁻³ at 1100° C.

Under IR/UV light, the Ko is assumed to be same as that at 1100° C. So, the exchange current density J₀ is estimated at 35.89 mA/cm² (specific to reaction temperature)

### CURRENT DENSITY VS OVERPOTENTIAL CORRELATION

The Butler-Volmer relation is obtained by plotting i against 1. The i versus n (overpotential) curve that was obtained looks much like the plot of a hyperbolic sine function. It has been said that the symmetry factor is about 0.5. Hence, the current density should be limited to minimize overpotential. The symmetry factor of 0.5 addresses both sides of the curve.

### THE EXTENDED BUTLER-VOLMER EQUATION

The more general form of the Butler-Volmer equation, applicable to the mass transfer-influenced conditions, can be written as:

$$j = {j}_{0} \{ \frac{{c}_{o} ( 0 , t )}{{c}_{o}^{*}} exp [ \frac{{α}_{a} zF η}{R T} ] - \frac{{c}_{r} ( 0 , t )}{{c}_{r}^{*}} exp [ - \frac{{α}_{c} zF η}{RT} ] \}$$

where:
j is the current density, A/m²,
cₒ and cᵣ refer to the concentration of the species to be oxidized and to be reduced, respectively,
c(0,t) is the time-dependent concentration at the distance zero from the surface of the electrode.

The above form simplifies to the conventional when the concentration of the electroactive species at the surface is equal to that in the bulk. There are two rates that determine the current-voltage relationship for an electrode. The charge transfer rate is the rate of the chemical reaction at the electrode, which consumes reactants and produces products. The mass transfer rate is the rate at which reactants are provided and products removed from the electrode region by various processes, including diffusion, migration, and convection. These two rates determine the concentrations of the reactants and products at the electrode, which are in turn determined by them. The slowest of these rates will determine the overall rate of the process.

The TCS production rate can be described by the following equation:

$${N}_{TCS} = j {A}_{e} / {n}_{e} F$$

Where:
N_{TCS}=TCS produced in moles/sec/cell
Ae=Area of each cell, cm²
j=current density, A/cm²
nₑ=number of electrons transferred
F=Faraday's constant

These equations and electrolytic cell, e.g., single cell reactor 600, can be used to determine the electrode material and the operating parameters of the hydrogenation reaction in an electrolytic cell consistent with the present disclosure.

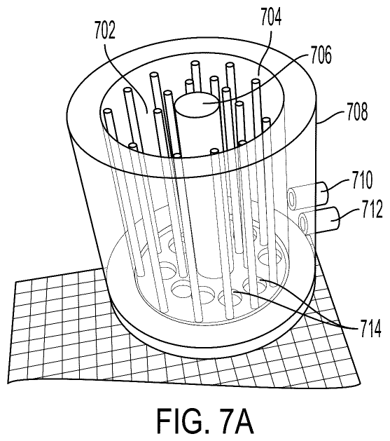

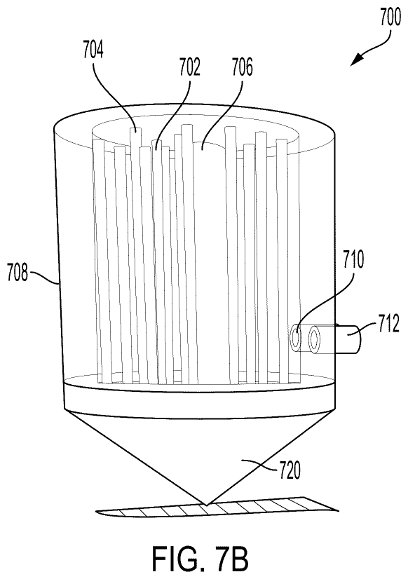

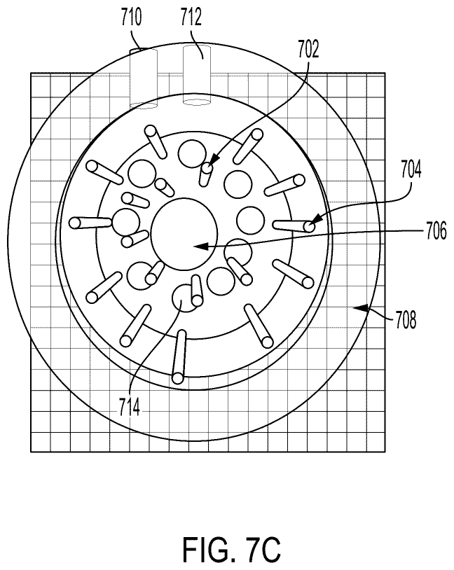

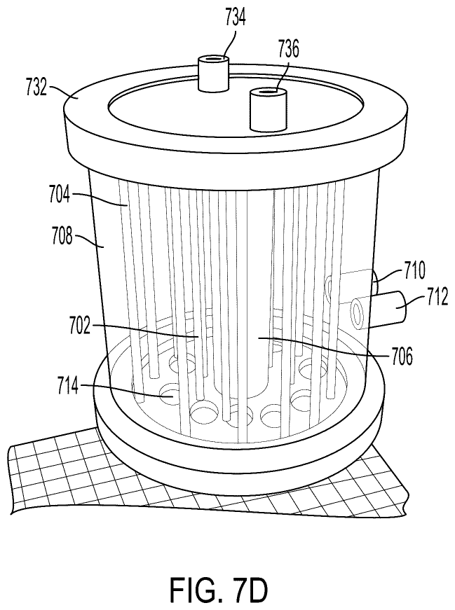

FIGS. 7A-7D illustrate an additional exemplary design of a single cell reactor 700 that is consistent with the present disclosure. FIGS. 7A-7D are provided as an example to aid in describing the present technology. Although a particular arrangement of components is depicted in FIGS. 7A-7D, the arrangement of such components should not be considered limiting of the present technology unless otherwise specified in the appended claims.

FIG. 7A is an isometric view of the cylindrical cell reactor 700, FIG. 7B is a side view of the cylindrical cell reactor 700, FIG. 7C is a top view of cylindrical cell reactor 700, and FIG. 7D is an isometric view of cylindrical cell reactor 700, including the reactor enclosure.

In exemplary embodiment FIG. 7A, the cylindrical cell reactor 700 includes reactor chamber 708, where the hydrogenation reaction of STC to TCS can be undertaken. The reactor chamber 708 can, for example, be cylindrical and run at pressures up to 24 bar_{g}, with the pressure being optimized to control reaction rate and yield. Furthermore, the reactor chamber 708 can include heaters, either integrated or external, that control the temperature of the reactor chamber 708. The hydrogenation reaction in cylindrical cell reactor 700 can be kept between about 60° C. and 200° C. The reactor chamber 708 can be used with STC in either the liquid form or gas form, depending on the optimized temperature and pressure for the desired yield and reaction rate.

Within the reactor chamber 708, UV light 704 and IR light 706 can be used to photo-assist the reaction taking place in the reactor chamber 708, e.g., a hydrogenation reaction. For example, the UV-light 704 can take the form of a plurality of rods within the reactor chamber 708 that are capable of emitting UV and/or IR light. In one exemplary embodiment, there are 10 UV light capable rods placed in reactor chamber 708. However, depending on the radius of the reactor chamber 708, more or fewer light emitting rods may be needed to meet the excitation energy to initiate the reaction at the desired temperature. In addition or in place of UV light 704, IR light 706 in FIG. 7A is a central rod that can emit IR light and can be used as the photo-assist device to facilitate the reaction. For example, each of the UV lights 704 and/or IR light 706 can emit light to assist in a photo-assisted electrosynthesis by using single or multiple absorption bands of IR/UV Light Enhancement. The UV light source is preferably in the range of 10 nm to 400 nm, more preferably 40 nm to 400 nm, and most preferably 200 nm to 320 nm. The IR light is preferably in the range of 1.4 μm to 15 μm, more preferably 8 μm to 15 μm, and most preferably 12.5 μm. The reaction can also be undertaken without UV or IR light. Methane (CH₄) has absorption bands in the infrared region around 2917 cm⁻¹ (asymmetric stretching) and 2963 cm⁻¹ (symmetric stretching) due to C—H stretching vibrations. Chlorine gas (Cl₂) has absorption bands in the infrared region around 546 cm⁻¹ (bending vibration) and 781 cm⁻¹ (stretching vibration) due to the Cl—Cl bond vibrations.

Further, the photo-assisted reaction in rector reactor chamber 708 can be further assisted via the inclusion of catalysts in the reactor chamber 708 of FIG. 7A. In one exemplary embodiment, there are 8 catalyst strings 702. However, depending on the environment of the reaction and the reaction taking place, a person of skill in the art would understand that the need for more or fewer catalytic strings may be necessary. The catalysts can be, for example, titanium oxide or cerium oxide.

The cylindrical cell reactor 700 can be fed via reactant inlet 710 and hydrogen inlet 712. In one exemplary embodiment, the reactants, e.g., STC and hydrogen, are added to the reactor chamber 708, where they can interact with the UV lights 704 and/or IR light 706 and the catalyst strings 702 to form the final products of TCS and byproducts, e.g., HCl. Furthermore, there are outlet holes 714 to collect any solid byproducts, e.g., carbon.

In exemplary embodiment, FIG. 7B, the cylindrical cell reactor 700 includes reactor chamber 708, where the hydrogenation reaction of STC to TCS can be undertaken. Consistent with FIG. 7A, FIG. 7B includes UV lights 704 and/or IR light 706 and catalyst strings 702. Reactant inlet 710 and H₂ gas inlet 712 are where the reactants are fed into cylindrical cell reactor 700. Furthermore, this side view of cylindrical cell reactor 700 includes the reactor bottom cone 720, which collects any solid reaction byproducts from a reaction in reactor chamber 708, e.g., carbon reaction byproducts.

In exemplary embodiment FIG. 7C, the cylindrical cell reactor 700 includes reactor chamber 708, where the hydrogenation reaction of STC to TCS can be undertaken. Consistent with FIG. 7A, FIG. 7C includes UV lights 704 and/or IR light 706 and catalyst strings 702. Reactant inlet 710 and H₂ gas inlet 712 are where the reactants are fed into cylindrical cell reactor 700. Furthermore, this top view of cylindrical cell reactor 700 includes the components of cylindrical cell reactor 700 described with respect to FIG. 7A.

In exemplary embodiment FIG. 7D, the cylindrical cell reactor 700 includes reactor chamber 708, where the hydrogenation reaction of STC to TCS can be undertaken. Consistent with FIG. 7A, FIG. 7D includes UV lights 704 and/or IR light 706 and catalyst strings 702. Reactant inlet 710 and H₂ gas inlet 712 are where the reactants are fed into cylindrical cell reactor 700. Furthermore, this top view of cylindrical cell reactor 700 includes the components of cylindrical cell reactor 700 described with respect to FIG. 7A. Further, FIG. 7D includes the top of cylindrical cell reactor 700, reactor enclosure 732. The reactor enclosure 732 encloses the reactor chamber 708 to sustain the temperature and pressure within the reactor. The reactor enclosure 732 of FIG. 7D can further include additional UV and/or IR light emitters (not shown) to photo-assist the reaction in reactor chamber 708. Further, if an additional catalyst is needed and/or a different catalyst from the catalyst strings 702 is needed for a particular reaction, catalyst feed 734 can be used to add and/or supplement the catalysts in the reactor chamber 708. Furthermore, the outlet stream for reactor chamber 708, gas outlet 736, can be used to remove the products of a hydrogenation reaction, e.g., TCS and/or HCl.

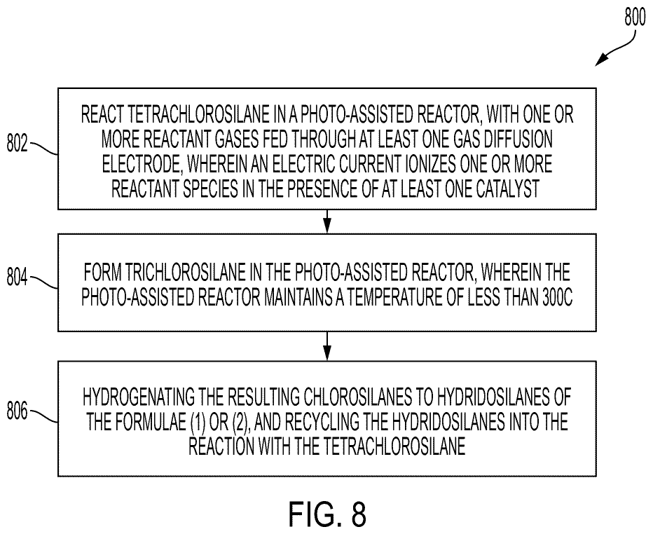

FIG. 8 illustrates an example method for using the reactors of FIGS. 1-7, showing a reactor design for low-temperature hydrogenation of silicone tretachlroide to trichlorosilane, with a catalyst and light enhancement. Although the example method depicts a particular sequence of operations, the sequence may be altered without departing from the scope of the present disclosure. For example, some of the operations depicted may be performed in parallel or in a different sequence that does not materially affect the function of the method.

Additionally, some of the depicted operations may be optional, and some operations that are not depicted might be part of the method. In other examples, different components of an example device or system that implements the method may perform functions at substantially the same time or in a specific sequence.

In block 802, routine 800 reacts silicone tretachlroide in a photo-assisted reactor, with one or more reactant gases fed through at least one gas diffusion electrode, wherein an electric current ionizes one or more reactant species in the presence of a catalyst. For example, in reactors 100, 400, 500, 600, and 700 the trichlorosilane can be prepared in high yields from tetrachlorosilanes and hydrogen or hydridosilanes, which process is energy saving, proceeds at low temperatures, and allows a simple separation of the trichlorosilane from by-products.

In accordance with the present invention, a process for the preparation of trichlorosilane (HSiCl₃) is provided, which comprises the reaction of tetrachlorosilane (SiCl₄) with either hydrogen or hydridosilanes in the presence of a catalyst.

In a preferred embodiment of the present invention, the hydridosilanes are selected from the group consisting of the formulae:

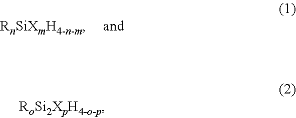

wherein
R is an organic group,
X is halogen or alkoxy,
n is 0 to 3, preferably 1 to 3, more preferably 2,
m is 0 to 2, preferably 0, and
n+m=0 to 3, preferably 1 to 3, more preferably 2,
is 0 to 5, preferably 1 to 5,
p is 0 to 5, preferably 0, and
o+p=1 to 5

In the above formulae (1) and (2), R is preferably selected from aromatic or aliphatic hydrocarbon groups, preferably with up to 6 carbon atoms, preferably from C₁ to C₆ alkyl groups or C₂ to C₆ alkenyl groups, and more preferably from C₁ to C₄ alkyl groups.

In one example, the organic groups (R) can be the same or different, and preferably R includes an aromatic group, such as phenyl, tolyl, and/or an aliphatic hydrocarbon group, R can also include an alkyl group, such as methyl, ethyl, n-, or iso propyl, n-butyl, sec-butyl, isobutyl, tert-butyl, n-pentyl, tert-pentyl, neopentyl, isopentyl, sec-pentyl, n-, iso or sec-hexyl n-, iso or sec-heptyl, n-, iso or sec-octyl etc., R can also be a n-alkyl group, or an alkenyl group. Further examples of R include one or more of methyl, ethyl, vinyl, n-propyl, iso-propyl, allyl, tert.-butyl, n-butyl, n-hexyl, phenyl, para-tolyl, benzyl, and mesityl, or mixtures thereof. An example of a most preferred R group is a methyl group.

In one example, X can be a halogen atom, preferably chlorine, bromine, and another example of preferable groups for X include an alkoxy group such as C₁ to C₆ alkoxy, preferably methoxy or ethoxy.

In one example, the hydridosilanes are preferably selected from the group consisting of SiH₄, MeSiH₃, Me₃SiH, Me₂SiH₂, Et₂SiH₂, MeSiHCl₂, Me₂SiHCl, PhSiH₃, Ph₂SiH₂, PhMeSiH₂, iPr₂SiH₂, Hex₂SiH₂, tBu₂SiH₂, Me₂Si(OEt)H, ViSiH₃, ViMeSiH₂, Me₂HSi—SiHMe₂, MeH₂Si—SiH₂Me, MeH₂Si—SiHMe₂, Me₃Si—SiHMe₂, Me₃Si—SiH₂Me, H₃Si—SiH₃, HSi₂Cl₅, preferably MezSiH₂.

In one illustrative example, the process of block 802 can also preferably be carried out in the presence of at least one catalyst, which promotes the selective reduction of the SiCl₄ to HSiCl₃. The catalyst can also be a combination of two or more of the proposed catalysts. The catalysts listed below are placed in gas diffusion membrane 202 of FIGS. 1 and 4, anode gas diffusion layer 506 of FIG. 5, membrane 610 of FIG. 6, catalyst strings 702 and catalyst feed 734 of FIG. 7A-D. Catalysts that are appropriate to use with this reduction reaction include:
R¹₄QZ, wherein R¹ is independently selected from hydrogen or one of the organic groups (R) listed above, preferably R¹ is an aromatic group or aliphatic hydrocarbon group, even more preferably a n-alkyl group, and most preferably a n-butyl group, Q is phosphorus, nitrogen, arsenic, antimony or bismuth, and Z is halogen,
phosphines of the formula R¹₃P, wherein R¹ is as defined above, preferably one of the organic groups (R) listed above, preferably PPh₃ or n-Bu₃P,
amines of the formula R¹₃N, wherein R¹ is as defined above, preferably one of the organic groups (R) listed above, preferably n-Bu₃N or NPh₃,
N-heterocyclic amines, preferably non-N-substituted methylimidazoles, such as 2-methylimidazole, and 4-methylimidazole,
an alkali metal halide, such as LiCl, and
an alkaline earth metal halide.

In a preferred embodiment of the present disclosure, the process of block 802 for the preparation of trichlorosilane is carried out in the presence of a catalyst of the formula R¹₄QZ, wherein R¹ is an organyl group, more preferably an aliphatic hydrocarbon group, even more preferably a n-alkyl group, and most preferably a n-butyl group, Q is phosphorus or nitrogen, and Z is chlorine, Preferred catalysts are selected from the group consisting of:
quaternary ammonium or phosphonium compounds, such as:
   R¹₄PCl, wherein R¹ is hydrogen or an organyl group, which can be the same or different, more preferably an aromatic group or aliphatic hydrocarbon group, even more preferably a n-alkyl group, and most preferably a n-butyl group, such as n-Bu₄PCl,
   R¹₄NCl, wherein R¹ is hydrogen or an organyl group, which can be the same or different, more preferably an aromatic group or aliphatic hydrocarbon group, even more preferably a n-alkyl group, and most preferably a n-butyl group, such as n-Bu₄NCl,
phosphines of the formula R¹₃P, wherein R¹ is hydrogen or an organyl group, preferably an organyl group, preferably the phosphine is PPh₃ or n-Bu₃P,
amines of the formula R¹₃N, wherein R¹ is as defined above, preferably an organyl group, preferably the amine is n-Bu₃N or NPh₃,
N-heterocyclic amines, preferably non-N-substituted methylimidazoles, such as 2-methylimidazole, and 4-methylimidazole, preferred are N-heterocyclic amines with a free nucleophilic electron pair at the nitrogen atom, which means that the nucleophilicity at the nitrogen atom in such N-heterocyclic amines is not reduced by inductive or mesomeric interactions. In particular, cyclic amides are normally not suitable as redistribution catalysts,
an alkali metal halide, such as NaCl, KCl, LiCl,
an alkaline earth metal halide, such as MgCl₂, CaCl₂.

In another exemplary embodiment, the process of block 802 can include redistribution catalysts that are selected from the compounds of the general formula R¹₄PCl, or R¹₄NCl, where R¹ is hydrogen or an organyl group and R¹ can be the same or different, preferably R¹ is an aromatic group such as R above, such as phenyl, tolyl, and/or an aliphatic hydrocarbon group, more preferably R is an alkyl group, such as methyl, ethyl, n-, or iso propyl, n-butyl, sec-butyl, isobutyl, tert-butyl, n-pentyl, tert-pentyl, neopentyl, isopentyl, sec-pentyl, n-, iso or sec-hexyl n-, iso or sec-heptyl, n-, iso or sec-octyl etc., even more preferably R is a n-alkyl group, and most preferably the compound of the general formula R₄PCl or R₄NCl are n-Bu₄PCl or n-Bu₄NCl.

In another exemplary embodiment, preferred catalysts are selected from triorganophosphines PR¹₃, R¹ is hydrogen or an organyl group such as R above and R¹ can be the same or different, more preferably R¹ is an alkyl such as described before, cycloalkyl or aryl group, most preferably the organophosphine is PPh₃ or n-Bu₃P. Further preferred catalysts are selected from triorganoamines NR¹₃, R¹ is preferably an organyl group, more preferably R is an alkyl group, and most preferably the triorganoamine is n-Bu₃N or NPh₃. Further preferred catalysts are N-heterocyclic amines such as non-N-substituted methylimidazoles such as 2-methylimidazole, and 4-methylimidazole, most preferably 2-methylimidazole.

In an exemplary embodiment of process of block 802 of FIG. 8, the molar ratio of the catalyst in relation to the tetrachlorosilane can be preferably in the range of about 0.0001 mol-% to about 600 mol-%, more preferably about 0.01 mol-% to about 20 mol-%, even more preferably about 0.05 mol-% to about 2 mol-%, and most preferably about 0.05 mol-% to about 1 mol-%. Furthermore, for purposes of calculating the percentage molar ratio can be [n (molar amount of the catalyst)/n (molar amount of the tetrachlorosilane)]×100. Using this formula a person of skill in the art is able to determine the molar ratio.

In another preferred embodiment according to the present disclosure, the process of block 802 can have the compounds of formula R¹₄PCl formed in situ from compounds of the formulae R¹₃P and R¹Cl, wherein R¹ is H or an organyl group as defined above. Similarly, in accordance with the present disclosure, the R¹₄PCl compound or R¹₄NCl compound can be also formed in situ, from R¹₃P or R¹₃N and R¹Cl by combination of the compounds in the reaction vessel, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D. Each of which represents where the reaction is performed. According to the present disclosure, the most preferred catalysts are n-Bu₄PCl and n-Bu₄NCl.

In another exemplary embodiment of process 800, process block 802 can be used to prepare trichlorosilane by reacting tetrachlorosilane with dimethylsilane. In an example of a preferred embodiment, the present disclosure can prepare trichlorosilane using a reaction of tetrachlorosilane with dimethylsilane according to one or both of the following reaction equations:

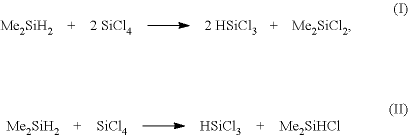

Accordingly, the choice between reaction (I) and (II) will often be based on the desired byproduct of the TCS reaction. If a byproduct of Me₂SiCl₂ is preferred, then reaction (I) is chosen. However, if a byproduct of Me₂SiHCl is preferred, then reaction (II) is chosen. Me₂SiCl₂ and Me₂SiHCl are both intermediates in the manufacture of silicones and functionalized silicones, the molar ratio can be selected accordingly. Also, in this particular process the catalysts preferably selected from R¹₄QZ, as defined above, wherein R¹ is an organyl group, more preferably an aliphatic hydrocarbon group, even more preferably a n-alkyl group, and most preferably a n-butyl group, Q is phosphorus or nitrogen, and Z is chlorine, and most preferably the catalyst is selected from n-BusPCl and n-Bu₄NCl.

In another exemplary embodiment of the present disclosure, TCS can be prepared by reacting Me₃SiH+SiCl₄→Me₃SiCl+HSiCl₃ in one of the reaction vessels, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D. Each of which represents where the reaction is performed.

The process for the preparation of trichlorosilane according to process 800 of FIG. 8, can be carried out in the presence or absence of a solvent. If a solvent is used in the process of the present disclosure, the reaction can be carried out in the presence of one or more solvents, preferably selected from ether solvents. In an exemplary embodiment, the solvents, if used, can be added to the reaction vessel, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D via a reactant port, e.g., STC port 112, STC inlet 614, or reactant inlet 710. Each of which represents where the reaction is performed. According to the present disclosure, the ether solvents can be selected from ether compounds, preferably one of a linear and a cyclic aliphatic ether compound. In the present disclosure, the term “ether compound” shall mean any organic compound containing an ether group —O—, in particular of formula R²—O—R³, wherein R² and R³ are independently selected from an organyl group R such as those mentioned above. Preferably, in exemplary embodiments, the R represents an organyl group, which is bound to the silicon atom via a carbon atom, and which organyl group can be the same or different. In the exemplary embodiment, the organyl group can be a substituted or unsubstituted group and the substituted group can be selected from: alkyl, aryl, alkenyl, alkynyl, alkaryl, aralkyl, aralkenyl, aralkynyl, cycloalkyl, cycloalkenyl, cycloalkynyl, cycloaralkyl, cycloaralkenyl, and cycloaralkynyl. Preferably, in an exemplary embodiment, the R group is selected from alkyl, cycloalkyl, alkenyl, aryl, methyl, vinyl and phenyl, and most preferably R is a methyl group (Me).

Preferably, R² and R³ can be either substituted or unsubstituted linear or branched alkyl groups or aryl groups. R² and R³ can have further heteroatoms such as oxygen, nitrogen, or sulfur. In the case of cyclic ether compounds, R² and R³ can constitute together an optionally substituted alkylene or arylene group, which may have further heteroatoms such as oxygen, nitrogen, or sulfur. The ether compounds can be symmetrical or asymmetrical with respect to the substituents at the ether group-O—. Also, a mixture of one or more ether compounds and one or more non-ether compounds can be used as solvent. Preferably, the one or more non-ether compounds forming the mixture with one or more ether compounds are selected from solvents which are less polar than the ether compounds used, particular preferably from aliphatic or aromatic hydrocarbons. In a further preferred embodiment of the process 800, the ether compounds used as solvents are selected from the group of linear, cyclic or complexing ether compounds. Herein, a linear ether compound is a compound containing an ether group R²—O—R³ as defined above, in which there is no connection between the R² and R³ group except the oxygen atom of the ether group, as for example in the symmetrical ethers Et₂O, n-Bu₂O, Ph₂O or diisoamyl ether (i-Pentyl₂O), in which R² is equal to R³, or in unsymmetrical ethers as t-BuOMe (methyl t-butyl ether, MTBE) or PhOMe (methyl phenyl ether, anisol). A cyclic ether compound used as solvent is a compound in which one or more ether groups are included in a ring formed by a series of atoms, such as for instance tetrahydrofurane, tetrahydropyrane or 1,4-dioxane, which can be substituted e.g. by alkyl groups. In linear ether compounds, also more than one ether group may be included forming a di-, tri-, oligo- or polyether compound, wherein R² and R³ constitute organyl groups when they are terminal groups of the compounds, and alkylene or arylene groups when they are internal groups. Herein, a terminal group is defined as any group being linked to one oxygen atom which is part of an ether group, while an internal group is defined as any group linked to two oxygen atoms being a constituent of ether groups. Preferred examples of such compounds are dimethoxy ethane, glycol diethers (glymes), in particular diglyme or tetraglyme, without being limited thereto. In the sense of present invention, the term “complex ether” is understood as an ether compound as defined above which is capable of complexing cations, preferably metal cations, more preferably alkali and alkaline metal cations, even more preferably alkaline metal cations, and most preferably lithium cations. Preferred examples of such complex ethers according to the invention are glycol diethers (glymes), in particular diglyme, triglyme, tetraglyme or pentaglyme, or crown ethers, in particular 12-crown-4, 15-crown-5, 18-crown-6, dibenzo-18-crown-6, and diaza-18-crown-6 without being limited thereto. The ether solvent is preferably selected from the group consisting of linear ethers, such as diethyl ether, di-n-butyl ether, complexing ethers, such as dimethoxy ethane, diethylene glycol dimethyl ether (diglyme) or tetraethylene glycoldimethyl ether (tetraglyme), alkylated polyethylene glycols (alkylated PEGs), cyclic ethers such as dioxane, preferably 1,4-dioxane, 2-methyltetrahydrofurane, tetrahydrofurane, or tetrahydropyrane. In an exemplary embodiment of the process 800 the ether compound is a high-boiling ether compound, preferably diglyme or tetraglyme. The term “high-boiling ether compound” is defined as an ether compound according to above definition with a boiling point at 1.01325 bar (standard atmosphere pressure) of preferably at least about 70° C., more preferably at least about 85° C., even more preferably at least about 100° C., and most preferably at least about 120° C. High-boiling ethers can facilitate separation of the desired products from the reaction mixture containing the solvent and residual starting materials. The products in general have lower boiling points than the starting materials, and the boiling points of these products are also lower than the boiling point of high-boiling ethers of above definition. For instance, the respective boiling point (at standard atmosphere pressure) of HSiCl₃ is 32° C., while a representative higher-boiling ether compound diglyme has a boiling point of about 162° C. Application of higher-boiling point ether compounds as solvents allows higher reaction temperatures to be utilized and simplifies separation of the desired products from the reaction mixture by distillation.

The process for the preparation of trichlorosilane according to the present disclosure is preferably carried out at a temperature in the range of about −40° C. to about 250° C., more preferably in the range of about 0° C. to about 200° C., still more preferably in the range of about 25° C. to about 150° C. In an exemplary embodiment, each reaction vessel, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D can be kept at a temperature in the range of about −40° C. to about 250° C.

The process for the preparation of trichlorosilane according to the present disclosure is preferably carried out at a pressure from about 0.1 to about 10 bar, preferably the reaction is carried out at about normal pressure (about 1013 mbar). In an exemplary embodiment, each reaction vessel, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D can be kept within a pressure range from about 0.1 to about 10 bar.

The process of the present invention is preferably carried out under inert conditions. In accordance with the present disclosure, the term “inert conditions” means that the process is partially or completely carried out under the exclusion of surrounding air, in particular of moisture and oxygen. In order to exclude ambient air from the reaction mixture and the reaction products, closed reaction vessels, reduced pressure and/or inert gases, in particular nitrogen or argon, or combinations of such means may be used.

The process of the present disclosure can be carried out continuously or discontinuously, such as batch wise.

In block 804, routine 800 forms trichlorosilane in the photo-assisted reactor, wherein the photo-assisted reactor maintains a temperature of less than 300° C. For example, in an exemplary embodiment, each reaction vessel, e.g., reaction chamber 104 of FIG. 1, reaction chamber 404 of FIG. 4, internal reactor chamber 512 of FIG. 5, reaction chamber 606 of FIG. 6, reactor chamber 708 of FIG. 7A-D, with the inclusion of the reactants as described above, along with the catalysts and photo-assist can from trichlorosilane.

In an exemplary embodiment of block 804, the resulting trichlorosilane and the chlorosilanes formed from the hydridosilanes are separated from the reaction mixture by distillation. The term “distillation” in the sense of the present disclosure relates to any process for separating components or substances from a liquid mixture by selective evaporation and condensation. Therein, distillation may result in practically complete separation, leading to the isolation of nearly pure components, or it may be a partial separation that increases the concentration of selected components of the mixture. The distillation processes can be simple distillation, fractional distillation, vacuum distillation, short path distillation, or any other kind of distillation known to the skilled person. The step of separating the trichlorosilane and the chlorosilanes formed from the hydridosilanes can comprise one or more batch distillation steps or can comprise a continuous distillation process.

After step 804, a particularly preferred process of the block 806 comprises further steps of hydrogenating the resulting chlorosilanes to hydridosilanes of the formulae (1) or (2), and recycling the hydridosilanes into the reaction with tetrachlorosilane.

For example, in the particular process for the preparation of trichlorosilane, which comprises the reaction of tetrachlorosilane with dimethylsilane preferably according to the reaction equations (I) or (II):

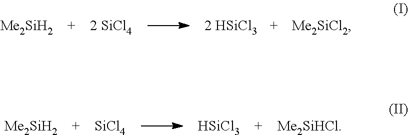

The resulting Me₂SiCl₂ or Me₂SiHCl are separated and at least a part thereof or all thereof are hydrogenated to Me₂SiH₂, which is used again in the reaction with tetrachlorosilane. Preferably the step of hydrogenating the chlorosilanes is carried out with a hydrogenation agent selected from the group consisting of metal hydrides, preferably selected from the group of alkali metal hydrides, such as LiH, NaH, KH, alkaline earth metal hydrides, such as calcium hydride, or complex metal hydrides, such as LiAlH₄, NaBH₄, n-Bu₃SnH, (i-Bu₂AlH) 2 or sodium bis(2-methoxyethoxy)aluminum hydride, more preferably the hydrogenation agent is selected from LiAlH₄, LiH, CaH₂ or LiH which is formed in situ by admixture of LiCl and NaH and subsequent heating said mixture to a temperature in the range of about 60° C. to about 200° C.

Suitable hydrogenation agents of block 806 generally include metal hydrides, therein preferably selected from binary metal hydrides, such as LiH, NaH, KH, CaH₂ or MgH₂, complex metal hydrides, such as LiAlH₄ or NaBH₄, and organometallic hydride reagents, such as n-Bu₃SnH, i-Bu₂AlH or sodium bis(2-methoxyethoxy) aluminum hydride, or a hydrogenation agent selected from boron-containing hydride donors, more preferably selected from organohydridoboranes, hydridoboranates, hydridoboronates and hydridoborates, even more preferably hydridoboranates, hydridoboronates and hydridoborates generated from the corresponding boranates, boronates and borates being the Lewis acid part of a frustrated Lewis acid/Lewis base pair and H₂. The use of tin hydrides is generally less preferred. The most preferred hydrogenation agent is lithium hydride.

In a preferred embodiment of the process according block 806, the amount of the hydrogenation agents, in particular of the metal hydride, preferably LiH in the hydrogenation reaction in relation to the chlorosilane compounds is in the range of about 1 mol-% to about 600 mol-%, preferably about 1 to about 400 mol-%, more preferably about 1 to about 200 mol-%, most preferably about 25 to about 150 mol-%, based on the total molar amount of the chlorine atoms present in chlorosilane compounds.

As described above the most preferred hydrogenation source is LiH, which is converted into lithium chloride (LiCl) in this reaction. In a particular preferred embodiment of such process using lithium hydride the LiCl formed is separated and subjected to the steps of purification, optionally mixing with KCl to prepare the LiCl—KCl eutectic composition, electrolysis of the eutectic or molten LiCl to obtain metallic Li and regeneration of LiH from the Li so prepared.

It is the particular advantage of this embodiment that it renders the process of the present invention economical and efficient including in particular in the conversion reaction (Di→M₂H), by recycling and valorizing the accruing LiCl and converting it back into LiH. Therefore, the costs of the Li-metal appearing in both components (LiH and LiCl) is eliminated from the overall cost consideration and only the conversion costs involved in converting LiCl back into LiH is to be considered. In addition, recycling is going along the incumbent manufacturing route for LiH. In fact, the hydride material is made from LiCl in two sequential steps: a) electrolysis of the LiCl in the form of a eutectic system (with, e.g., KCl, Downs-Cell/Process) resulting in Li-metal; followed by step b) the hydrogenation of the Li-metal at elevated temperatures with hydrogen gas (H₂), which results into LiH (schematically):

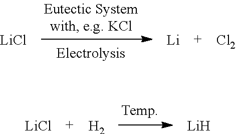

The complete stoichiometry of the two reaction equations is 2LiCl→2Li+Cl₂ and 2Li+H₂→2LiH, respectively.

The hydrogenation reaction of block 806 is preferably carried out in the presence of one or more solvents, preferably selected from ether solvents such as those described above.

Accordingly, a particularly preferred embodiment of the present disclosure relates to a process for the preparation of trichlorosilane, which comprises
A) the reaction of tetrachlorosilane with dimethylsilane according to the reaction equation (I) or (II):

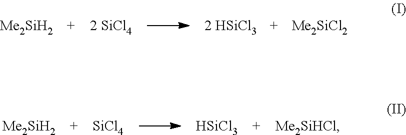

Reaction equations (I) and (II) can include the presence of a catalyst of the formula R¹₄QZ, wherein R¹ is an organyl group, more preferably an aliphatic hydrocarbon group, even more preferably a n-alkyl group, and most preferably a n-butyl group, Q is phosphorus or nitrogen, and Z is chlorine,
B) separating the HSiCl₃ and Me₂SiCl₂ or Me₂SiHCl from the reaction mixture,
C) hydrogenating the Me₂SiCl₂ or Me₂SiHCl or part thereof with a hydrogenating agent which is selected from metal hydrides, preferably LiH, to form Me₂SiH₂, and
D) recycling the Me₂SiH₂, into step A).

The process described in FIG. 8, allows for the preparation of trichlorosilane with high selectivity. In particular, the selectivity of the formation of HSiCl₃ is preferably at least 90%, more preferably at least 95% and most preferably at least 99%. That is, in accordance with the process of the present disclosure, tetrachlorosilane is selectively reacted to trichlorosilane without any significant formation of higher hydrides such as H₂SiCl₂, H₃SiCl and H₄Si.

Also, the conversion rates in the process 800 of the present disclosure are preferably at least 90%, preferably at least 95%, and still more preferably at least 99%. The term conversion rate in the present disclosure means that if for example Me₂SiH₂ is reacted and all hydrogen atoms are used to form HSiCl₃, the conversion rate is 100%. When other monosilanes are also formed (e.g., Me₂SiHCl), the conversion rate is accordingly reduced. The following examples are to illustrate:
Example 1) Me₂SiH₂+2SiCl₄→Me₂SiCl₂+2HSiCl₃ correspond to 100% conversion.
Example 2) 10Me₂SiH₂+20SiCl₄→5Me₂SiCl₂+15HSiCl₃+5Me₂SiHCl+5SiCl₄ (remaining)→75% conversion rate (because 75% of all hydrogen atoms were used to form HSiCl₃, and 25% used for the formation of Me₂SiHCl).
Example 3) 10Me₂SiH₂+20SiCl₄→10Me₂SiHCl+10HSiCl₃+10SiCl₄ (remaining)

This results in a 50% conversion rate since only half of all hydrogen atoms used were used to form HSiCl₃.

Accordingly, for a 100% conversion rate, the hydridosilane used must be completely chlorinated to form HSiCl₃ and must not retain any of its hydrogen atoms. Accordingly, the conversion rate is defined by the formulas (number of hydrogen atoms of the HSiCl₃ formed)/(total number of hydrogen atoms used of the hydridosilane used) or (number of hydrogen atoms of the hydridosilane used, which led to the formation of HSiCl₃)/(total number of hydrogen atoms of the hydridosilane used), or otherwise (for monosilanes R₄₋ₙSiHₙ) (molar amount of HSiCl₃ formed)/[(molar amount of R₄₋ₙSiHₙ used)*n] (for disilanes one would have to adapt the formula accordingly). While usually conversion rates of 100% are desirable, it is possible to operate at lower conversion rates to form, e.g., Me₂SiHCl, which can be used in the formation of functionalized polysiloxanes.

In the process 800 for the preparation of trichlorosilane according to the present disclosure, preferably the molar ratios of the hydridosilanes to tetrachlorosilane (SiCl₄) is in the range of about 0.05 to about 2, preferably in the range of about 0.08 to about 1.5, even more preferably in the range of about 0.09 to about 1, most preferably about 0.1 to about 0.9.

In a preferred embodiment of the present disclosure in the process 800 for the preparation of trichlorosilane the hydridosilanes are formed in situ from chlorosilanes and LiH. In a preferred embodiment of this in situ process SiCl₄ is reacted with LiH. It is assumed that in such process SiH₄ (in situ formed) reduces excess SiCl₄ to give HSiCl₃ selectively, whereas the monosilane formation from SiCl₄ and LiH (described by W. Sundermeyer, DE1080077, 1957; W. Sundermeyer, L. M. Litz, Chem. Ing. Tech 1965, 37, 14-18; H. J. Klockner, M. Eschwey, Chem. Ing. Tech. 1988, 60, 815-821) gives the perhydrogenated silane lacking any selectivity.

It will be understood that any numerical range recited herein includes all sub-ranges within that range and any combination of the various endpoints of such ranges or sub-ranges, be it described in the examples or anywhere else in the specification.

It will be also understood that each number recited herein may be subject to a certain inaccuracy, so that each number should be associated with “about”.

It will also be understood herein that any of the components of the disclosure herein as they are described by any specific genus or species detailed in the examples section of the specification, can be used in one embodiment to define an alternative respective definition of any endpoint of a range elsewhere described in the specification with regard to that component, and can thus, in one non-limiting embodiment, be used to supplant such a range endpoint, elsewhere described.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

While the above description contains many specifics, these specifics should not be construed as limitations on the scope of the disclosure, but merely as exemplifications of preferred embodiments thereof. Those skilled in the art may envision many other possible variations that are within the scope and spirit of the invention as defined by the claims appended hereto.

What is claimed is:

1. A method for preparation of trichlorosilane comprising:
reacting silicone tetrachloride in a photo-assisted reactor, with one or more reactant gases fed through at least one gas diffusion electrode, wherein an electric current ionizes one or more reactant species with a catalyst; and
forming the trichlorosilane in the photo-assisted reactor, wherein the photo-assisted reactor maintains a temperature of less than 300 C.

2. The method for the preparation of trichlorosilane according to claim 1, wherein the catalyst is at least one of platinum, palladium, nickel, titanium oxide, or cerium oxide.

3. The method for the preparation of trichlorosilane according to claim 1, wherein the one or more reactant gases include at least one chlorosilane or hydridosilane selected from the group consisting of: 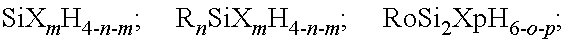
where R is an organic group;
where X is halogen or alkoxy;
where n is 0 to 3;
where m is 0 to 2;
where n+m is 0 to 3;
where p is 0 to 5; and
where o+p is 1 to 5.

4. The method of claim 3, wherein R is chosen from aromatic or aliphatic hydrocarbon groups with up to 6 carbon atoms.

5. The method of claim 3, wherein the at least one chlorosilane or hydridosilanes are selected from the group consisting of SiCl₄, SiH₂Cl₂, SiH₃Cl, SiHCl₃, and SiH₄.

6. The method of claim 3, wherein the at least one chlorosilane or hydridosilanes are selected from the group consisting of SiH₄, MeSiH₃, Me₃SiH, Me₂SiH₂, Et₂SiH₂, MeSiHCl₂, Me₂SiHCl, PhSiH₃, Ph₂SiH₂, PhMeSiH₂, iPr₂SiH₂, Hex₂SiH₂, tBu₂SiH₂, Me₂Si(OEt)H, ViSiH₃, ViMeSiH₂, Me₂HSi—SiHMe₂, MeH₂Si—SiH₂Me, MeH₂Si—SiHMe₂, Me₃Si—SiHMe₂, Me₃Si—SiH₂Me, and H₃Si—SiH₃, preferably Me₂SiH₂.

7. The method of claim 3, wherein the one or more reactant gases is selected from the group consisting of SiH₄, chlorine, methane, ethane, or oxygen.

8. The method of claim 1, wherein the photo-assisted reactor uses infrared light when the one or more reactant gases is methane or chlorine.

9. The method of claim 1, further comprising:
reacting tetrachlorosilane according to at least one of the following reaction equations:

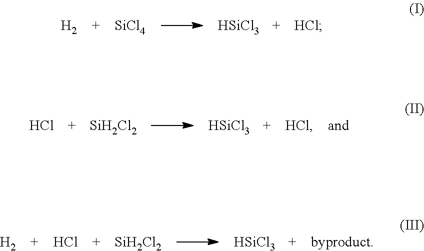

10. The method of claim 1, further comprising:
reacting tetrachlorosilane with dimethylsilane according to at least one of the following reaction equations:

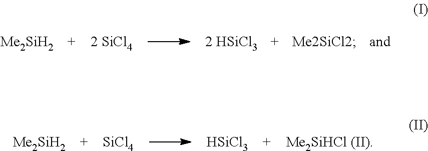

11. The method of claim 10, wherein the reacting is carried out in the presence of a compound R¹₄QZ, wherein R¹ is an organyl group, Q is phosphorus or nitrogen, and Z is chlorine.

12. The method of claim 1, wherein the reacting includes at least one of a solvent or an additive to improve ionic conductivity.

13. The method for the preparation of trichlorosilane according to claim 1, wherein reacting takes place at a temperature in the range of about −40° C. to about 250° C.

14. The method for the preparation of trichlorosilane according to claim 1, wherein reacting takes place at a pressure from about 0.1 to about 10 bar.

15. The method for the preparation of trichlorosilane according to claim 1, wherein reacting takes place under inert conditions.

16. The method for the preparation of trichlorosilane according to claim 1, further comprising:
hydrogenating resulting chlorosilanes to hydridosilanes and recycling the hydridosilanes into the reaction with tetrachlorosilane.

17. The method for the preparation of trichlorosilane according to claim 16, further comprising:
adding at least one hydrogenation agent selected from the group consisting of metal hydrides and alkaline earth metal hydrides, and further comprising:
after adding the at least one hydrogenation agent, heating the silicone tetrachloride to a temperature in the range of about 60° C. to about 200° C.

18. A method comprising:
reacting, in a photo-assisted reactor, tetrachlorosilane and dimethylsilane in the presence of a catalyst of the formula R¹₄QZ, wherein R¹ is an organyl group, Q is phosphorus or nitrogen, and Z is chlorine to form at least HSiCl₃, Me₂SiCl₂, and Me₂SiHCl;
removing the HSiCl₃, Me₂SiCl₂, and Me₂SiHCl from the photo-assisted reactor;
hydrogenating at least a portion the Me₂SiCl₂ and the Me₂SiHCl with at least one metal hydride to form Me₂SiH₂; and
recycling the Me₂SiH₂ back into the photo-assisted reactor.

19. An electrosynthesis reactor comprising:
at least one anode;
a photo-assist device in fluid communication with the at least one anode, wherein the photo-assist device includes at least one of a UV light and an IR light;
a cathode mount adjacent to the photo-assist device, wherein the cathode mount includes a gas exit;
a gas diffusion electrode layer in fluid communication with the photo-assist device, wherein the gas diffusion electrode layer includes a catalyst;
at least one bipolar plate in fluid communication with the gas diffusion electrode layer, wherein the at least one bipolar plate includes an HCl exhaust;
a hydrophobic PTFE membrane adjacent to the gas diffusion electrode layer; and
an internal reaction chamber including a cathode in fluid communication with the hydrophobic PTFE membrane, wherein the cathode includes at least chlorosilane vapor.

20. The electrosynthesis reactor of claim 19, wherein the UV light is a plurality of rods and the IR light is centrally located in the electrosynthesis reactor.
